(19) United States
(12) Patent Application Publication
(10) Pub. No.: US 2024/0227963 A1
(43) Pub. Date: Jul. 11, 2024

(54) Vehicle Windshield

(71) Applicant: Richard Sargente, Warwick, NY (US)

(72) Inventor: Richard Sargente, Warwick, NY (US)

(21) Appl. No.: 18/151,671

(22) Filed: Jan. 9, 2023

(51) Int. Cl. B62J 17/04; B32B 3/02; B62K 11/00

(52) U.S. Cl. CPC B62J 17/04; B32B 3/02; B62K 11/00; B60F 5/00; B62K 2204/00

(57) ABSTRACT

A windshield for a vehicle, the windshield including a first translucent layer and a second layer. The second layer includes side walls and a central portion, the side walls being fixedly connected to a first side of the first layer. The central portion of the second layer is spaced apart from the first layer. Openings between the first layer and the second layer are limited to an upper opening at a top side of the second layer and to a lower opening at a bottom side of the second layer.

### FIELD OF THE DISCLOSED TECHNOLOGY

The disclosed technology relates generally to vehicle windshields, and, more specifically, to vehicle windshields which are open to the air above the windshield.

### BACKGROUND OF THE DISCLOSED TECHNOLOGY

Motorcycle windshields are designed to deflect wind to go above the rider's head, rather than hitting the rider in the face. The windshield of a motorcycle should be selected to be the right height to direct the air stream above the rider's helmet, and to enable good visibility to the rider such that a rider can look over the windshield.

However, many times, the air stream causes turbulence between the windshield and the rider, resulting in significant discomfort for the rider such as violent shaking of the head. Various types of motorcycle wind deflectors have been proposed for this purpose. Most wind deflectors extend the windshield upward, so that air, as well as insects and debris, are directed to flow above the rider's helmet, making sure to keep the rider and his/her helmet cleaner during the process. However, such deflectors often reduce the visibility for the rider, and obstruct the view of the rider.

There remains a need in the art for a motorcycle wind deflector which provides better aerodynamics, while ensuring good visibility to the rider and minimize turbulence and buffeting.

### SUMMARY OF THE DISCLOSED TECHNOLOGY

The present disclosure relates to vehicle windshields, and, more specifically, to motorcycle windshields which are open to the air above the windshield and provide improved aerodynamics.

In accordance with an embodiment of the disclosed technology, there is provided a windshield for a vehicle. The windshield includes a first translucent or transparent layer and a second layer. The second layer includes side walls and a central portion, the side walls being fixedly connected to a first side of the first layer. The central portion is spaced apart from the first layer and openings between the first layer and the second layer are limited to an upper opening at a top side of the second layer and to a lower opening at a bottom side of the second layer.

In some embodiments, the lower opening is wider than the upper opening, such that a space between the first layer and the central portion of the second layer is tapered.

In some embodiments, a distance between the second layer and the first layer is greater at the lower opening than at the upper opening.

In some embodiments, a front side of the first layer is parallel to a front side of the central portion of the second layer.

In some embodiments, the second layer is transparent or translucent.

In some embodiments, the second layer is tinted. In some embodiments, the second layer is opaque.

In some embodiments, the second layer is disposed entirely within the area of the first layer.

In some embodiments, the second layer does not extend beyond boundaries of the first layer, in the height direction and/or in the width direction.

In some embodiments, the first layer is larger than the second layer in the height and width dimensions.

In some embodiments, the second layer is disposed closer to a base of the first layer than to an upper edge of the first layer.

In accordance with an embodiment of the disclosed technology, there is provided a vehicle, including a vehicle body, a motor, at least two wheels, and the windshield as described herein. The vehicle is open to the surrounding environment above the windshield.

In some embodiments, the vehicle is a motorcycle. In some embodiments, the vehicle is a convertible car.

### BRIEF DESCRIPTION OF THE DRAWINGS

FIG. 1 is a schematic side view illustration of a motorcycle including a motorcycle windshield common in the prior art.

FIG. 2 is a schematic side view illustration of a motorcycle including a motorcycle windshield according to an embodiment of the disclosed technology.

FIG. 3A is a first front perspective view of a motorcycle including a motorcycle windshield according to embodiments of the disclosed technology.

FIG. 3B is a second front perspective view of a motorcycle including a motorcycle windshield according to embodiments of the disclosed technology.

FIG. 3C is a third front perspective view of a motorcycle including a motorcycle windshield according to embodiments of the disclosed technology.

FIG. 4A is a side view planar illustration and a front view planar illustration of a motorcycle windshield according to embodiments of the disclosed technology.

FIG. 4B is a front perspective view planar illustration and a front view planar illustration of a motorcycle windshield according to embodiments of the disclosed technology.

### DETAILED DESCRIPTION OF EMBODIMENTS OF THE DISCLOSED TECHNOLOGY

In an embodiment of the disclosed technology, a windshield for a vehicle includes a first translucent layer and a second layer. The second layer includes side walls and a central portion, the side walls being fixedly connected to a first side of the first layer. The central portion of the second layer is spaced apart from the first layer. Openings between the first layer and the second layer are limited to an upper opening at a top side of the second layer and to a lower opening at a bottom side of the second layer.

Embodiments of the disclosed technology will become clearer in view of the following description of the drawings.

Reference is now made to FIG. 1 which is a schematic side view illustration of a motorcycle 10 including a motorcycle windshield 12 common in the art. As indicated by arrow 14, an air stream impinging upon windshield 12 will be deflected in an upward direction, to flow above motorcycle 10. However, the height to which the air stream is deflected is such that the deflected air stream often impacts the rider's face or helmet. This can cause the rider to feel as if their head is constantly being pounded, and can be very uncomfortable. Additionally, the air may flow over and behind the windshield 12, thus causing turbulence and noise which would disturb the rider.

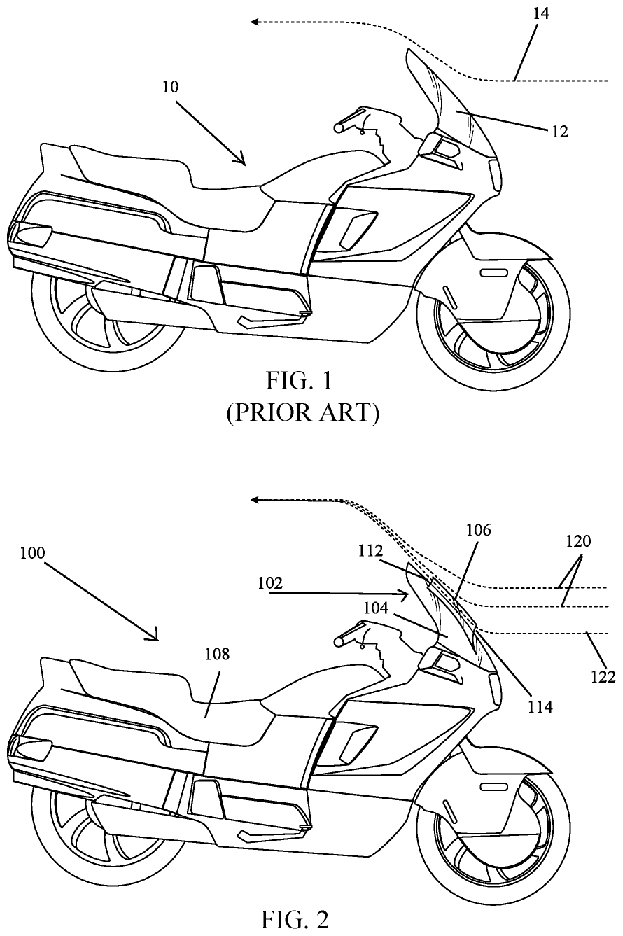

Reference is now made to FIG. 2, which is a schematic side view illustration of a motorcycle 100 including a motorcycle windshield 102 according to an embodiment of the disclosed technology. Motorcycle 100 is substantially identical to motorcycle 10 of FIG. 1.

As seen, windshield 102 includes a first translucent layer 104, and a second layer 106 mounted onto the first layer. First layer 104 of windshield 102 is substantially identical to windshield 12 of FIG. 1.

The second layer 106 is spaced apart from the first layer 104, and is attached to a front side of the first layer. Consequently, second layer 106 is farther from a seat 108 of the motorcycle than first layer 104. As seen, the dimensions of second layer 106 are smaller than those of first layer 104.

Reference is now additionally made to FIGS. 4A and 4B, which are, respectively, a side view planar illustration and a front view planar illustration of windshield 102.

As seen, second layer 106 is slightly curved, and includes a central portion 109 and side walls 110, which are integrally formed. Side walls 110 are fixedly connected to first layer 104, and secure the first and second layers to each other. Consequently, an upper opening 112 is disposed between the first and second layers at an upper edge of second layer 106, and a lower opening 114 is disposed between the first and second layers at a lower edge of the second layer. Typically, side walls 110 are fixed to first layer 104 such that openings between the first and second layers are limited only to the upper and lower edges of second layer 106. As such, windshield 102 is devoid of gaps between second layer 106 and first layer 104 along side walls 110 of the second layer.

In some embodiments, second layer 106 is substantially trapezoidal, such that upper opening 112 (and the upper edge of the second layer) is narrower, along the width of the windshield, than lower opening 114 (and the lower edge of the second layer). This arrangement creates a tunnel, such that air flow enters the space between first layer 104 and second layer 106 from lower opening 114 and exits from upper opening 112. Additionally, the air flow out of upper opening 112 is faster than the air flow into lower opening 114, due to Bernoulli's principle and the resulting venturi effect.

In some embodiments, central portion 109 of second layer 106 may be substantially parallel to first layer 104, such that a depth of upper opening 112 is substantially the same as a depth of lower opening 114. For the purpose of the present disclosure, the depth of the opening is defined as the maximal distance between the two layers, along the opening, measured in a direction perpendicular to the surface of first layer 104.

In some other embodiments, central portion 109 of second layer 106 may be disposed at an angle relative to first layer 104, such that the depth of upper opening 112 is smaller than the depth of lower opening 114. This may further enhance the venturi effect, and result in a faster flow of air out of the space between the two layers.

Second layer 106 is disposed close to the base of first layer 104, such that the presence of the second layer does not impede or disrupt the rider's view of the road. Further, it is a particular feature of the disclosed technology that second layer 106 is disposed entirely within the first layer 104, such that the second layer does not extend the height or width of the first layer. In the embodiment of FIGS. 2, 4A, and 4B, the first layer 104 is larger than the second layer 106 in both the width and height dimensions, and the second layer does not extend out of the footprint of the first layer.

Returning to FIG. 2, it is seen that when a rider rides motorcycle 100, some of the oncoming airflow flows over windshield 102, as indicated by arrows 120, while some of the airflow flows in the space between first layer 104 and second layer 106, as indicated by arrow 122. The structure of windshield 102, and the resulting flow of air in the space between first layer 104 and second layer 106, cause the air stream off windshield 102 to reach a greater distance above the windshield, thereby allowing the air to flow above the rider, and reducing the noise and turbulence experienced by the rider. Turbulence is also reduced by air flow being prevented from “escaping” to the sides of the windshield by the fixing of side walls 110 of the second layer to the first layer.

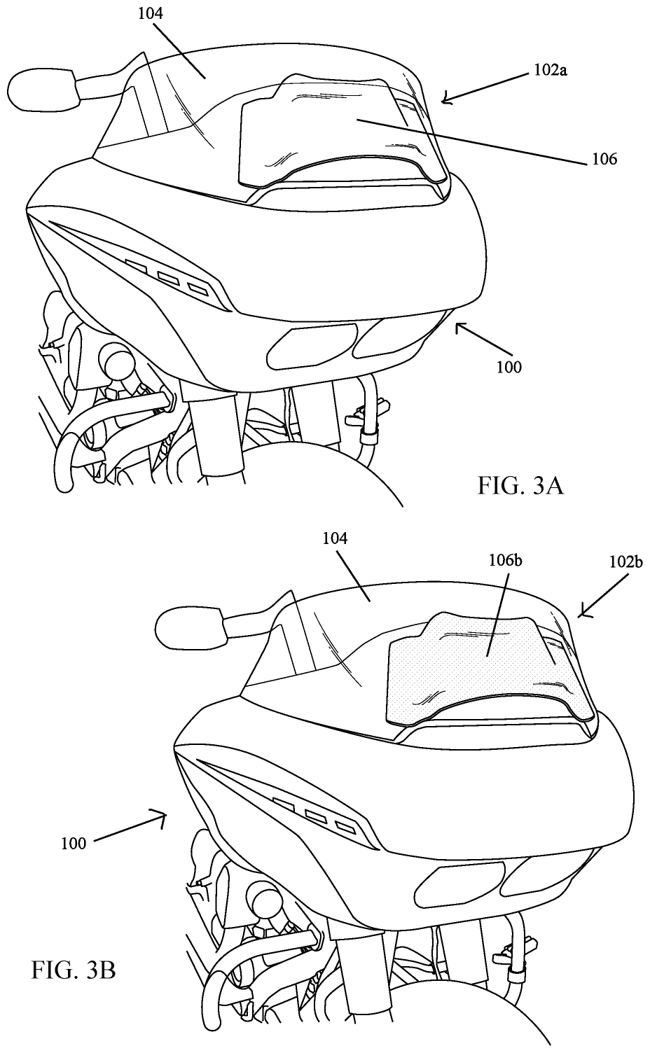

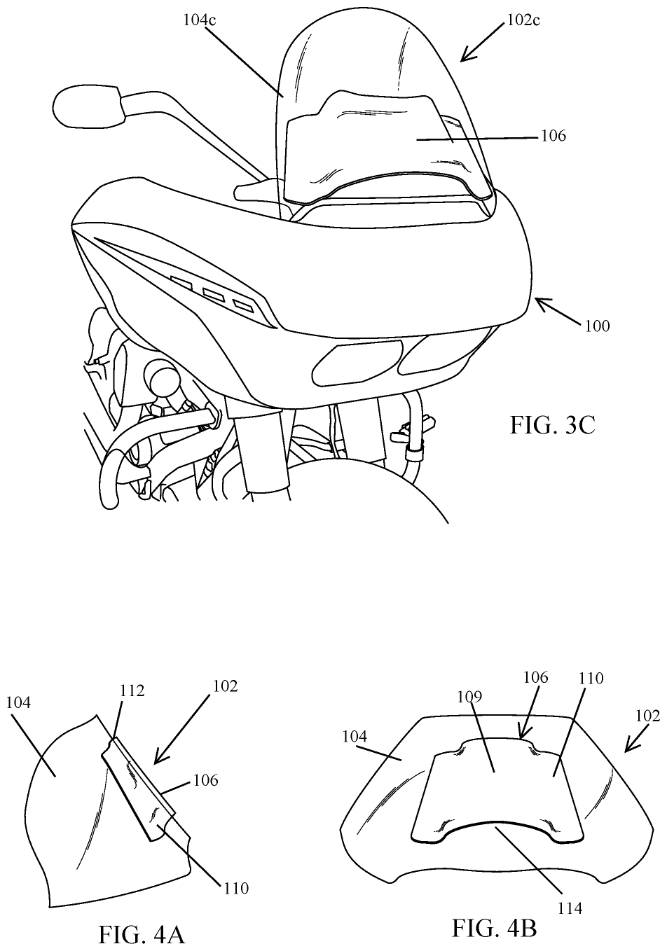

Reference is now made to FIGS. 3A, 3B, and 3C, which are front perspective view illustrations of motorcycle 100 including a motorcycle windshield according to embodiments of the disclosed technology.

FIG. 3A illustrates motorcycle 100 with windshield 102a, which includes transparent first layer 104, as shown in FIG. 2, and a transparent second layer 106, also as shown in FIG. 2.

In FIG. 3B, motorcycle 100 includes a windshield 102b, having a transparent first layer 104 as shown in FIG. 2, and a tinted, or even opaque, second layer 106b. It is to be appreciated that the color of second layer 106b does not obstruct the rider's view of the road, since the rider's line of sight is through the portion of first layer 104 disposed above second layer 106b.

In FIG. 3C, windshield 102c includes a smaller first layer 104c, which substantially does not extend to the sides of the motorcycle, and a second layer 106, similar to that shown in FIGS. 2 and 3A. As seen, despite first layer 104c being smaller, second layer 106 is still disposed entirely within the first layer 104c, such that the second layer does not extend the height or width of the first layer.

While the windshield of the disclosed technology is described herein with respect to a motorcycle, two-layer windshields according to this technology are suitable for any vehicle which is open to the air above the windshield, such as a convertible or roofless vehicle, including convertible cars, safari vehicles, and open tour buses. In the context of the present specification and claims, the term “approximately” is defined as being within 10% of a target number or measure.

For purposes of this disclosure, the term “substantially” is defined as “at least 95% of” the term which it modifies.

When the term “or” is used, it creates a group which has within either term being connected by the conjunction as well as both terms being connected by the conjunction.

It should be understood that the use of “and/or” is defined inclusively such that the term “a and/or b” should be read to include the sets: “a and b,” “a or b,” “a,” “b.”

Any device or aspect of the technology can “comprise” or “consist of” the item it modifies, whether explicitly written as such or otherwise.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods and apparatuses described hereinabove are also contemplated and within the scope of the invention.

1. A windshield for a vehicle, the windshield comprising:
a first translucent layer; and
a second layer including side walls and a central portion, the side walls being fixedly connected to a first side of the first layer such that the central portion is spaced apart from the first layer and openings between the first layer and the second layer are limited to an upper opening at a top side of the second layer and to a lower opening at a bottom side of the second layer.

2. The windshield of claim 1, wherein the lower opening is wider than the upper opening, such that a space between the first layer and the central portion of the second layer is tapered.

3. The windshield of claim 1, wherein a distance between the second layer and the first layer is greater at the lower opening than at the upper opening.

4. The windshield of claim 1, wherein a front side of the first layer is parallel to a front side of the central portion of the second layer.

5. The windshield of claim 1, wherein the second layer is transparent or translucent.

6. The windshield of claim 1, wherein the second layer is tinted.

7. The windshield of claim 1, wherein the second layer is opaque.

8. The windshield of claim 1, wherein the second layer is disposed entirely within the area of the first layer.

9. The windshield of claim 1, wherein the second layer does not extend beyond boundaries of the first layer, in the height direction.

10. The windshield of claim 1, wherein the second layer does not extend beyond boundaries of the first layer, in the width direction.

11. The windshield of claim 1, wherein the first layer is larger than the second layer in the height and width dimensions.

12. The windshield of claim 1, wherein the second layer is disposed closer to a base of the first layer than to an upper edge of the first layer.

13. A vehicle, comprising:
a vehicle body;
a motor;
at least two wheels; and
the windshield according to claim 1,
wherein the vehicle is open to the surrounding environment above the windshield.

14. The vehicle of claim 13, wherein the vehicle is a motorcycle.

15. The vehicle of claim 13, wherein the vehicle is a convertible car.
